(19) United States
(12) Patent Application Publication
(10) Pub. No.: US 2009/0311048 A1
(43) Pub. Date: Dec. 17, 2009

(54) MINERAL HARDPAN FORMATION FOR STABILIZATION OF ACID- AND SULFATE-GENERATING TAILINGS

(76) Inventors: John F. Horst, Newton, PA (US); Jeff Gillow, Highlands Ranch, CO (US); Suthan S. Suthersan, Yardley, PA (US)

Correspondence Address: SHERIDAN ROSS PC, 1560 BROADWAY, SUITE 1200, DENVER, CO, 80202, US

(21) Appl. No.: 12/477,906

(22) Filed: Jun. 3, 2009

Related U.S. Application Data
(60) Provisional application No. 61/058,532, filed on Jun. 3, 2008.

(51) Int. Cl. B09C 1/08

(52) U.S. Cl. 405/128.5

(57) ABSTRACT

The invention provides methods of stabilizing mine tailing through the formation of solid evaporate mineral surface hardpan thereby stabilizing mine tailings and decreasing environmental contamination surrounding a tailings impoundment.

### RELATED APPLICATIONS

The present application claims the benefit of priority under 35 U.S.C. § 119(e) to U.S. Provisional Application Ser. No. 61/058,532, filed Jun. 3, 2008, which is incorporated herein by this reference in its entirety.

### FIELD OF THE INVENTION

The invention is generally related to environmental remediation of mining operations and specifically, methods of stabilizing tailings through the formation of solid evaporate mineral crusts or “hardpan.”

### BACKGROUND OF INVENTION

Typical mining operations involve the extraction of metals and minerals from an ore body, vein, or seam. The ores must be processed, or mined, to extract the metals/minerals of interest from the waste rock. Tailings are produced as a consequence of these mining techniques. Tailings are the residual waste product of crushing, processing, and refining ore in mining operations and consist of unrecoverable and uneconomic metals, minerals, chemicals, organics, and process water. The exact composition of tailings depends upon the composition of the ore and the process of mineral extraction used on the ore.

Tailings are typically discharged, as slurry, to a tailings storage area on the ground surface in retaining structures called tailing impoundments. Tailing impoundments are typically configured as raised embankments or retention dams. These tailing impoundments can be very large, ranging from several acres to thousands of acres.

The disposal of tailings is commonly identified as the singe most important source of environmental impact for mining operations. In the last century alone, as the demand for metals and minerals has increased, the volume of tailings generated has grown dramatically. It is estimated that hundreds of thousands of tons of tailings are produced each day. Active impoundments in the Southwestern United States cover 10 square kilometers. The environmental impact of tailings impoundments often revolves around water management, and the leaching of dissolved solids (metals, sulfate) and in some cases acidity to groundwater and/or surface water. Where measures to control or prevent these types of impacts were not built into the initial design, implementing a system of control can be difficult due to the scale involved and this significantly complicates the impoundment operation. As a result, it is common to employ environmental remediation measures that are only marginally adequate or that provide only temporary solutions.

Tailing impoundments create a multitude of environmental concerns. For example, tailings often contain significant amounts of reactive minerals. Once placed in the tailings impoundment, these minerals will weather in the presence of moisture and oxygen to generate significant amounts of sulfate, acidity, and heavy metals. The products of reactive weathering can contaminate the environment outside of the tailing impoundment via the underlying groundwater or other receptors. Depending on the size of the impoundment and the types of minerals involved, migration of sulfate, acidity, and heavy metals can significantly impact the surrounding environment. In addition to ground and surface water contamination, dissolution and transport of metals by run-off and ground water, and acid drainage, windblown dispersal of contaminants and ecosystem disturbances are also environmental concerns.

Current remediation technologies encompass both ex-situ and in-situ methods including, excavation, dredging, surfactant enhanced aquifer remediation, pump and treat methods, solidification and stabilization, in situ oxidation, soil vapor extraction, bioremediation, and phytoremediation. Unfortunately, the current technologies are unsatisfactory for stabilizing acid and sulfate generating tailings. For example, most remediation technologies are expensive and require lengthy and arduous maintenance, testing, and monitoring.

Thus, there is a need for effective methods of stabilizing tailings and mitigating environmental effects of tailings impoundments that can be implemented cost effectively to existing as well as planned impoundments. The methods of this invention achieves these advantages and provides other advantages discussed more fully below.

### SUMMARY OF INVENTION

The invention provides methods of stabilizing mine tailing through the formation of solid evaporate mineral surface hardpan on top of the tailings impoundment, thereby stabilizing mine tailings and decreasing environmental contamination surrounding a tailings impoundment.

One embodiment of the invention is a method of stabilizing a mine tailing impoundment by applying an amendment to a surface of a tailings impoundment wherein the amendment causes the precipitation of a mineral mass on the surface of the tailing impoundment. The amendment contains a calcium source such as calcium oxide, calcium hydroxide, calcium chloride, Portland cement, cement kiln dust, lime or lime dust. Preferably, the amendment contains a source of calcium and a source of sulfate. More preferably, the amendment contains calcium sulfate.

In another embodiment the amendment contains one or both of lime and cement kiln dust. In another embodiment the amendment contains a source of iron.

The mineral mass formed typically will contain at least one of gypsum, calcite and aragonite.

Another embodiment is a method of reducing sulfate contamination of ground water from a mine tailing by applying a source of calcium to a surface of a mine tailings impoundment to form a mineral mass on the surface of the tailing impoundment that reduces vertical percolation of water containing sulfates trough the tailing impoundment.

Another embodiment is a method of capturing water from an active mining operation by applying an amendment containing a calcium source to a surface of a tailings impoundment to form a mineral mass precipitate on the surface of the tailing impoundment such that water can be captured from the surface of the mineral mass before it passes into the tailings impoundment. This water may be used in an active mining operation.

### BRIEF DESCRIPTION OF THE DRAWINGS

The accompanying drawings illustrate various embodiments of the invention and together with the general description of the invention given above and the detailed description of the drawings below, serve to explain the principles of these inventions.

FIG. 1 illustrates the tailings treatment methodology of the present invention.

FIG. 2 shows geochemical modeling of gypsum precipitation in tailings water.

It should be understood that the drawings are not necessarily to scale. In certain instances, details that are not necessary for an understanding of the invention may have been omitted. It should be understood that the invention is not necessarily limited to the particular embodiments illustrated herein.

### DESCRIPTION OF EMBODIMENTS

The present invention is drawn to a method for stabilizing tailings and mitigating the environmental effects through the formation of a solid evaporate mineral crust or “hardpan.” A hardpan is formed when soil becomes cemented together by bonding agents such as, iron oxide or calcium carbonate, to form a hard impervious mass.

Hardpan layers decrease the overall permeability of a tailing impoundment and can be used on sulfide-bearing trailing impoundments to reduce the amount of infiltration and reduce production of acid drainage. Limestone/lime react with acidic rock, resulting in precipitation of a hardpan layer at the surface of the tailings, which significantly reduces the permeability of the tailings impoundment and reduces the infiltration of water into the tailings and into the surrounding environment.

The first description of hardpans that formed on tailings impoundments was provided in 1991 and these were attributed to iron and sulfate precipitates due to oxidation of sulfidic mineral phases (Blowes, D. W., et al., 1991. The formation and potential importance of cemented layers in inactive sulfide mine tailings. Geochimica et Cosmochimica Acta 55(4): 965-978). Recent studies on hardpans has focused on evapoconcentration and mineral changes in tailings and the formation of aluminum, iron, and calcium sulfate mineral precipitates at the tailings surface (Acero, P., et al., 2007. Coupled thermal, hydraulic and geochemical evolution of pyritic tailings in unsaturated column experiments. Geochimica et Cosmochimica Acta 71: 5325-5338). The key to hardpan formation is the formation of a sequence of cemented-layers, as described by Graupner et al. (2007. Formation of sequences of cemented layers and hardpans within sulfide-bearing mine tailings (mine district Freiberg, Germany). Applied Geochemistry 22(11): 2486-2508). This work showed that amorphous mineral phases act as a cementing agent for larger particles in the tailings. These amorphous phases have also been noted in alkaline slag waste dumps and consist of evaporates including calcium-rich minerals and silica-gel phases (Meima, J. A., et al., 2007. Geochemical modeling of hardpan formation in an iron slag dump. Minerals Engineering 20:16-25).

Laboratory testing of amendments to limestone or lime to assess the formation of a hardpan in sulfidic tailings were described by Chermak and Runnells (1995. Self-sealing harpan barriers to minimize infiltration of water into sulfide-bearing overburden, ore, and tailings piles. Proceedings of the Tailings and Mine Waste Conference, 1996). An added surface amendment of limestone and/or lime to pyritic tailings in a column showed that these components react with acidic rock, in the presence of water, to form a surface hardpan layer of gypsum and amorphous iron oxyhydroxide. These studies showed that the hardpan layer significantly reduced the effective permeability of water through the column. The hardpan layers were also shown to be self-healing in that cracks in the top of the column healed through re-precipitation of the hardpan minerals.

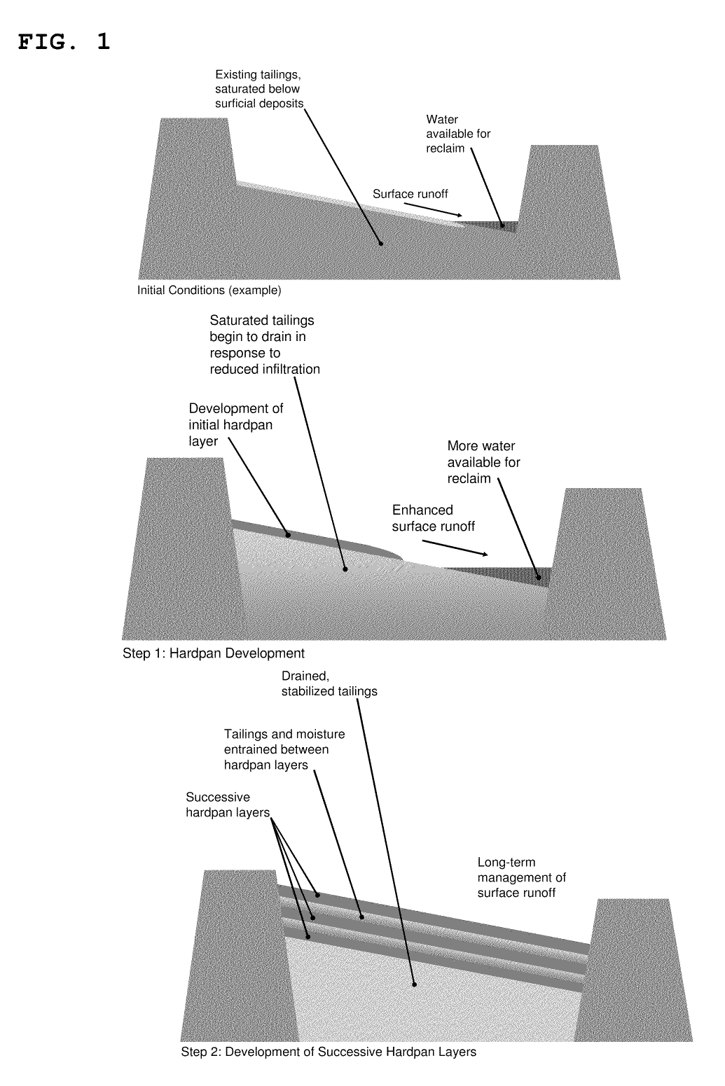

The methodology of the present invention provides an approach to curtail percolation of water through mine tailings by decreasing downward hydraulic conductivity, in turn increasing the volume of water reporting to reclaim pond(s). These methods conserve water, which is needed in large volumes to support mine operations, particularly in arid locations, where groundwater is one of the most precious natural resources. The methodology of the invention centers on engineering a mineral hardpan crust over the surface of the impoundment (potentially in successive layers) as depicted in FIG. 1. FIG. 1 shows the initial tailings impoundment with some surface water runoff that may accumulate and become available for reclimation. In response to the formation of an initial hardpan layer, the tailings will begin to drain as surface water runoff increases over the hardpan layer to reclimation pond(s). As successive hardpan layers are built up, surface water runoff collected or diverted as desired and drained tailings are stabilized beneath hardpan layers.

The hardpan production methodology of the invention is adaptable to the impoundment to be treated and the nature of the tailings it contains.

By stopping the percolation of additional water through the tailings, the impoundment drains down before the end of the mine operations, effectively eliminating the source of groundwater impacts and the flux of sulfate in time to coincide with mine closure. This approach is applicable for an operating impoundment as well as inactive impoundments. In addition to curtailing percolation and conserving water, this type of approach also reduces windblown dusts on the impoundment surface.

Thus, an embodiment of the invention includes the application of amendment(s) to surface tailings on active or inactive impoundments to form a solid, low-permeability evaporate mineral crust hardpan surface layer.

The mineral crust hardpan results from the engineered, massive precipitation of gypsum, calcite, aragonite and other minerals that contribute to a cemented mineral mass that solidifies and hardens upon drying. Amendment(s) suitable for use in this embodiment may include anything that will achieve super saturation with respect to targeted mineral forms, facilitating their precipitation. Preferred elements of the amendment are sources of calcium including, but not limited to, calcium oxide, calcium hydroxide, calcium chloride, Portland cement, cement kiln dust, lime and/or lime dust.

The low-permeability mineral hardpan stabilizes the surface tailings to minimize dust generation and impedes the percolation of water downward into deeper, underlying tailings thereby curtailing the recharge of inter-granular fluids. Over time, this allows the pore water in the tailings beneath the hardpan to drain out, eventually diminishing the seepage of impacted water from the base of the impoundment, thereby accomplishing effective contamination source control.

The low-permeability mineral hardpan will also promote more effective drainage of water (runoff) from the surface of the impoundment. At active mines this can be collected and put to beneficial use in the mine operation.

The low-permeability mineral hardpan can also passivate reactive sulfide minerals within the hardpan matrix to decrease their contribution to the production of acidity, sulfate, and metals.

Where applied at active tailings impoundments, the creation of multiple hardpan layers over time promotes the creation of a more competent interbedded composite layer to minimize the impacts of cracks that form due to drying and settling of the underlying materials.

To economically create a hardpan layer, the target mineral should form from readily available products with minimal waste of reactants. Ideally, the target mineral should be at or near equilibrium in the tailings impoundment so that nearly all the added material would result in precipitation of the target mineral.

Mineral saturation indices are indicators of the saturation state of a mineral with respect to a given water composition. If the saturation index for a particular mineral is less than zero, the mineral is under saturated with respect to the solution and would be anticipated to dissolve. Conversely, if the saturation index is greater than zero, the mineral is supersaturated with respect to the solution and would be anticipated to precipitate. Minerals with saturation indices equal to zero are at equilibrium with the surrounding solution and are thought to have minimal precipitation or dissolution occurring. Mineral species which are optimal for the formation of a hardpan are those which have saturation values near zero indicating equilibrium, or near equilibrium, conditions such that addition of the mineral components result in effective mineral precipitation.

In order to assess which mineral species are potential candidates to enhance the formation of a hardpan, the present inventors used published aqueous phase data from sulfide ore flotation circuits and tailings facilities for geochemical modeling (Subrahmanyam, T. V. and Forssberg, K. S. E. 1995. Technical note: Grinding and flotation pulp chemistry of a low grade copper ore. Minerals Engineering 8(8): 913-921; vanHuyssteen, E. 1998. The Relationship Between Mine Process Tailings Mineralogy and Pore Water Composition. Waste Characterization and Treatment. Littleton, CO. Society for Mining, Minerals and Exploration, p. 626). Geochemical equilibrium was simulated using the geochemical model and mineral saturation indices of minerals were calculated based on laboratory analyses from collected aqueous samples.

As a result of the high silica and calcium concentrations in aqueous phase, calcium and silica based minerals are supersaturated in tailings water. The most supersaturated minerals are calcite or aragonite (polymorphs of CaCO₃), and monohydrocalcite (CaCO₃-H₂O). Saturation indices are based on thermodynamic equilibrium and do not consider kinetics. Although thermodynamic modeling suggests that some minerals are supersaturated, they may not precipitate under ambient conditions. This is commonly true for minerals such as aragonite which forms at high temperature and pressure. Monohydrocalcite is the hydrous form of calcite and is expected to be present as calcite saturation increases.

Minerals near saturation include wallastonite (CaSiO₃), pseudowollastonite (CaSiO₃), rankinite (CA₃Si₂O₇), gypsum (CaSO₄), anhydrite (CaSO₄), bassanite (2CaSO₄), quartz (SiO₂), tridymite (SiO₂), chalcedony (SiO₂), cristobalite (SiO₂), portlandite (Ca(OH₂)), amorphous silica (SiO₂), and lamite (Ca₂(SiO₄)). Gypsum (CaSO₄-2H₂O) and calcite are present under ambient conditions and are the primary target minerals to enhance the formation of a hardpan.

Aqueous phase sample results indicated gypsum is near saturation in the spigot water data, and is supersaturated in tailings water and retention pond water. Gypsum saturation values are similar at all locations, but do not have identical values and range from −0.07 to 0.06, indicating that the mineral is near saturation. Thus, the addition of calcium and sulfate source(s) to tailings causes gypsum to precipitate without increasing the aqueous concentration of calcium and sulfate.

After evaluating potential mineral species to target for enhancement of the hardpan, the present inventors selected gypsum due to its presence within tailings and based on the geochemical modeling results indicating that the aqueous phase is in equilibrium with gypsum. Gypsum precipitation is therefore targeted to enhance the formation of hardpan surface layers in the methods of the invention.

The minerals calcite, hematite, and gypsum are all significant hardpan phases, and their presence and/or fresh precipitation supports cementation of the shallow tailings.

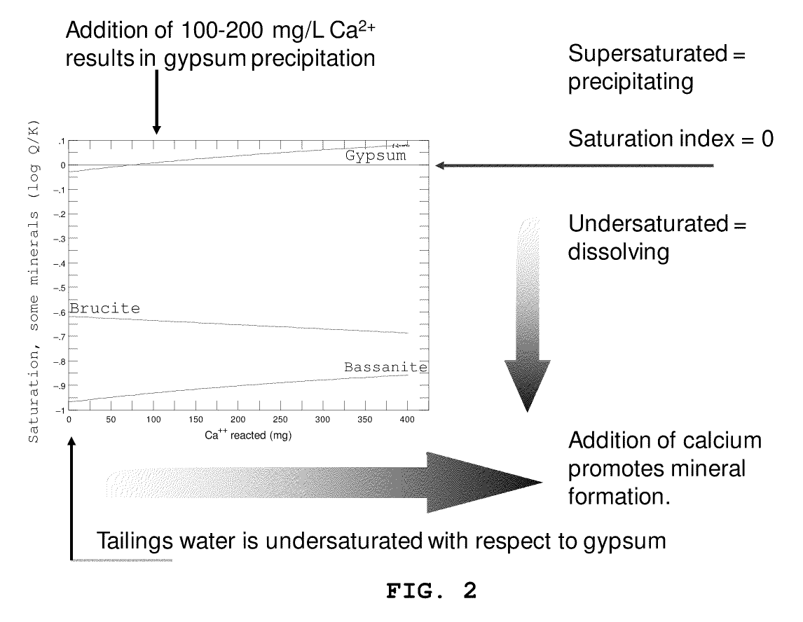

The addition of calcium to the surface of tailings results in massive mineral precipitation of both gypsum and calcite as shown in FIG. 2. Both of these minerals are important hardpan mineral phases and because impoundment water is at saturation for these minerals, it does not require a large amount of calcium to promote massive mineral precipitation.

Additional sulfate is not generated in the impoundment pore water through the addition of calcium sulfate, because additional calcium sulfate results in gypsum precipitation. Sulfate can be removed from the tailings water through the addition of various forms of calcium via calcium sulfate precipitation.

The addition of lime or cement kiln dust results in a further increase in pH across the impoundment and therefore promotes the precipitation of gypsum and calcite.

The addition of iron also promotes the formation of hardpan minerals and is useful as a minor component of the hardpan mineral composition due to its role as a cementing phase.

Given the physical and hydraulic properties of the tailings, the formation of a mineral hardpan enhances the anisotropy ratio (horizontal to vertical) of the hydraulic conductivity such that water flow changes from a predominately vertical flow to a more horizontally dominated flow. Similarly, the mechanical properties of the hardpan reduce the potential for desiccation cracks and reduce dust formation. As vertical percolation is reduced, the driving force responsible for sulfate migration into the ground water is curtailed.

The foregoing description of the present invention has been presented for purposes of illustration and description. Furthermore, the description is not intended to limit the invention to the form disclosed herein. Consequently, variations and modifications commensurate with the above teachings, and the skill or knowledge of the relevant art, are within the scope of the present invention. The embodiments described hereinabove are further intended to explain the best mode known for practicing the invention and to enable others skilled in the art to utilize the invention in such, or other, embodiments and with various modifications required by the particular applications or uses of the present invention. It is intended that the appended claims be construed to include alternative embodiments to the extent permitted by the prior art.

What is claimed is:

1. A method of stabilizing a mine tailing impoundment comprising applying an amendment to a surface of a tailings impoundment wherein the amendment causes the precipitation of a mineral mass on the surface of the tailing impoundment.

2. The method of claim 1, wherein the amendment comprises a calcium source selected from the group consisting of calcium oxide, calcium hydroxide, calcium chloride, Portland cement, cement kiln dust, lime and lime dust.

3. The method of claim 1, wherein the amendment comprises a source of calcium and a source of sulfate.

4. The method of claim 3, wherein the amendment comprises a calcium sulfate.

5. The method of claim 1, wherein the amendment comprises at least one of lime and cement kiln dust.

6. The method of claim 1, wherein the amendment comprises a source of iron.

7. The method of claim 1, wherein the mineral mass comprises at least one of gypsum, calcite and aragonite.

8. A method of reducing sulfate contamination of ground water from a mine tailing comprising applying a source of calcium to a surface of a mine tailings impoundment to form a mineral mass on the surface of the tailing impoundment that reduces vertical percolation of water containing sulfates trough the tailing impoundment.

9. The method of claim 8, wherein the mineral mass comprises at least one of gypsum, calcite and aragonite.

10. A method of capturing water from an active mining operation comprising:
applying an amendment comprising a calcium source to a surface of a tailings impoundment wherein the amendment causes the precipitation of a mineral mass on the surface of the tailing impoundment;
capturing water from the surface of the mineral mass on the tailing impoundment; and,
directing the water to an active mining operation.

11. The method of claim 10, wherein the amendment comprises a calcium source selected from the group consisting of calcium oxide, calcium hydroxide, calcium chloride, Portland cement, cement kiln dust, lime and lime dust.

12. The method of claim 10, wherein the amendment comprises a source of calcium and a source of sulfate.

13. The method of claim 12, wherein the amendment comprises a calcium sulfate.

14. The method of claim 10, wherein the amendment comprises at least one of lime and cement kiln dust.

15. The method of claim 10, wherein the amendment comprises a source of iron.

16. The method of claim 10, wherein the mineral mass comprises at least one of gypsum, calcite and aragonite.
